(19) United States
(12) Patent Application Publication
(10) Pub. No.: US 2021/0195929 A1
(43) Pub. Date: Jul. 1, 2021

(54) NO SUGAR ADDED MULTILAYER EDIBLE PRODUCTS COMPRISING A CENTER AND A BARRIER LAYER

(71) Applicant: KRAFT FOODS GROUP BRANDS LLC, CHICAGO, IL (US)

(72) Inventors: Allison Therese Nowak, Elk Grove Village, IL (US); Madeline Erickson Goris, Chicago, IL (US); Alexis Marie Fye, Hawthorn Woods, IL (US)

(21) Appl. No.: 16/731,515

(22) Filed: Dec. 31, 2019

(51) Int. Cl. A23L 25/00

(52) U.S. Cl. CPC A23L 25/25; A23V 2002/00

(57) ABSTRACT

A multilayer edible product includes a center; a barrier layer directly encompassing at least a portion of the center. The barrier layer includes a hydrophilic powder and a source of fat. The multilayer edible produce further includes an outer layer directly encompassing the barrier layer and indirectly encompassing the center. The center has at least one of a fat content that is either greater than or less than a fat content of the outer layer, or a water activity that is either greater than or less than a water activity of the outer layer. A composition of the barrier layer is different than a composition of the center and a composition of the outer layer, and the multilayer edible product does not include any added sugar.

### BACKGROUND

### Field

The present specification generally relates to multilayer edible products having a center and a barrier layer. In particular, the present specification relates to no sugar added multilayer edible products that include a nut-based center and a barrier layer that separates the nut-based center from an outer layer.

### Technical Background

Nut-based compositions, such as, for example, nut pastes or nut butters, are generally semi-solid at room temperature and when heated by conventional means, such as by microwave, there is minimal phase transition, resulting in a heated semi-solid nut-based composition. This semi-solid nut-based composition is not desirable to consumers, who prefer a gooey, semi-liquidus heated nut-based composition. In addition, when nut-based compositions are heated, they have a tendency to have an oil-phase separation that results in possible diffusion of layers adjacent to the nut-based composition. These drawbacks have prevented nut-based compositions from being used in edible food products, and particularly in edible food products with multiple layers that are to be heated to go through phase transition.

As noted above, fat and moisture migration from one layer of an edible food product due to fat differential gradients and water activity is a problem in food products. This migration can result in unstable products with short shelf lives and can cause microbial or product quality issues. Moreover, it is often desirable to eliminate certain components from food products, such as, for example, sugar and certain fats.

Accordingly, a need exists for no sugar added multilayer edible products that prevent migration of fat and moisture from the center to other layers of the multilayer edible products, and particularly prevents the migration of fat and moisture from nut-based centers.

### SUMMARY

According to one embodiment, a multilayer edible product comprises: a center; a barrier layer directly encompassing at least a portion of the center, the barrier layer comprising: a hydrophilic powder; and a source of fat; and an outer layer directly encompassing the barrier layer and indirectly encompassing the center, wherein the center has at least one of: a fat content that is either greater than or less than a fat content of the outer layer, or a water activity that is either greater than or less than a water activity of the outer layer, and wherein a composition of the barrier layer is different than a composition of the center and a composition of the outer layer, and the multilayer edible product does not include any added sugar.

In another embodiment, the center comprises: greater than or equal to 60.0 wt % pulverized nuts; greater than or equal to 5.0 wt % low-melting temperature fat; and greater than or equal to 5.0 wt % high-melting temperature fat, wherein the center has a viscosity less than or equal to 1000 Pa·s at temperatures less than or equal to 50° C.

Additional features and advantages of the protein products described herein and methods for making the same will be set forth in the detailed description which follows, and will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic depiction of a cross section of a no sugar added multilayer edible product according to embodiments disclosed and described herein; and

FIG. 2 is a schematic depiction of a cross section of a no sugar added multilayer edible product according to embodiments disclosed and described herein.

### DETAILED DESCRIPTION

Reference will now be made in detail to various embodiments of multilayer edible products comprising a center of the multilayer edible product and a barrier layer. Whenever possible, the same reference numerals will be used throughout the drawings to refer to the same or like parts. According to embodiments, a multilayer edible product comprises: a center; a barrier layer directly encompassing at least a portion of the center, the barrier layer comprising: a hydrophilic powder; and a source of fat; and an outer layer directly encompassing the barrier layer and indirectly encompassing the center, wherein the center has at least one of: a fat content that is either greater than or less than a fat content of the outer layer, or a water activity that is either greater than or less than a water activity of the outer layer, and wherein a composition of the barrier layer is different than a composition of the center and a composition of the outer layer, and the multilayer edible product does not include any added sugar. Various embodiments of no sugar added multilayer edible products comprising a center and a barrier layer will now be described with reference to the appended drawings.

It should be understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other.

Unless otherwise specified, a range of values, when recited, includes both the upper and lower limits of the range as well as any ranges there between. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

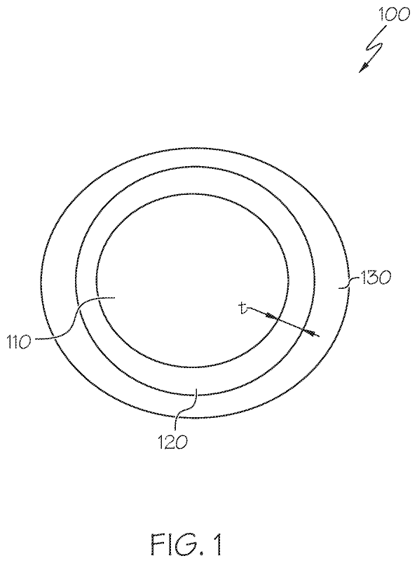

With reference now to FIG. 1, a cross section of a multilayer edible product 100 comprises a center 110, a barrier layer 120, and an outer layer 130. Although the embodiment of the multilayer edible product 100 depicted in FIG. 1 is cylindrical or spherical in shape, it should be understood that in embodiments, the multilayer edible product 100 may have any suitable geometrical shape. As shown in FIG. 1, according to embodiments, a center 110 is located at the middle of the multilayer edible product 100. Positioned on, and in physical contact with, the center 110 is a barrier layer 120. As mentioned hereinabove, fat and moisture has a tendency to migrate from the center 110 to an outer layer 130 of the multilayer edible product 100—such as the outer layer 130—that results in diffusion of the outer layer 130 with fat and moisture. The barrier layer 120 is positioned between, and in physical contact with, the center 110 and the outer layer 130 to prevent this migration of fat and/or moisture from the center 110 to the outer layers. Accordingly, in embodiments, the barrier layer 120 completely, and directly, encompasses the center 110. As used herein, “completely encompasses” means that the barrier layer 120 covers the center 110 in such a way that little to no fat or moisture is able to migrate from the center to the outer layer 130, and “directly” means that there is physical contact between layers (such as, physical contact between the center 110 and the barrier layer 120). In some embodiments, the barrier layer 120 does not completely encompass the center 110, but the barrier layer 120 covers the center so that any migration of fat or moisture from the center 110 to the outer layer 130 does not affect the flavor or consistency of the multilayer edible product 100.

As shown in FIG. 1, multilayer edible products 100 according to embodiments also include an outer layer 130 positioned on, and in physical contact with, the barrier layer 120, such that the barrier layer is present between, and in physical contact with, the center 110 and the outer layer 130. According to embodiments, the outer layer 130 indirectly encompasses the center 110. As used herein “indirectly encompasses” means that a layer surrounds, but is not in physical contact with, another layer (such as the outer layer 130 that surrounds the center 110, but the outer layer 130 is not in physical contact the center 110 because the barrier layer 120 is positioned between the center 110 and the outer layer 130).

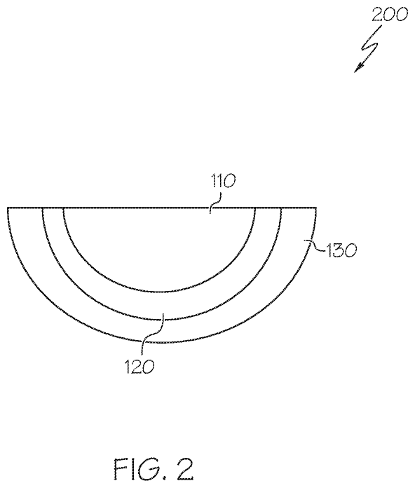

With reference now to FIG. 2, which is a cross section of multilayer edible products according to embodiments, multilayer edible products 200, according to embodiments, may comprise a barrier layer 120 and an outer layer 130 that do not encompass the center 110. According to the embodiment depicted in FIG. 2, the barrier layer 120 and the outer layer 130 cover only a portion of the center 110. In these embodiments, the barrier layer 120 is present between, and in physical contact with, the center 110 and the outer layer 130, and the outer layer 130 is not in physical contact with the center 110. Each of the center 110, the barrier layer 120, and the outer layer 130 of the multilayer edible product 100, 200 will be described in more detail below.

The Center

As described above, the center 110 of the multilayer edible product 100, 200 is, according to embodiments, generally located at the geometrical center of the multilayer food product 100, 200. However, in some embodiments, the center 110 may be located at any position of the multilayer food product 100, 200 so long as the center 110 is at least partially covered by the barrier layer 120 and the outer layer 130. For example, in some embodiments, the multilayer edible product 100, 200 may comprise a plurality of centers 110 at various positions within the multilayer edible product 100, 200, where each of the plurality of centers 110 is at least partially covered by the barrier layer 120 and the outer layer 130.

According to embodiments, the composition of the center 110 of the multilayer edible product 100, 200 has a fat content that is either greater than or less than the fat content of the outer layer 130 and/or has a water activity that is either greater than or less than the water activity of the outer layer 130. As described above, when there is a fat content differential between the center 110 and the outer layer 130 (such as when the fat content of the center 110 is either greater than or less than the fat content of the outer layer 130), and/or there is a water activity differential between the center 110 and the outer layer 130 (such as when the water activity of the center 110 is either greater than or less than the water activity of the outer layer 130), fat and/or moisture may migrate from the center 110 to the outer layer 130 or may migrate from the outer layer 130 to the center 110. It should be understood that the greater the difference between either or both of the fat content and the water activity of the center 110 and the outer layer 130, the more pronounced the migration of fat and/or moisture will be.

Although the composition of the center 110 is not particularly limited—so long as the center 110 has a fat content that is greater than or less than the fat content of the outer layer 130 and/or has a water activity that is greater than or less than the water activity of the outer layer 130—nut-based centers typically will have a fat content that is greater than the fat content of the outer layer 130 and/or nut-based centers typically have a water activity that is less than the water activity of the outer layer 130. In addition, the composition of the center according to embodiments disclosed and described herein does not include added sugar. As used herein, and as defined by the U.S. Food and Drug Administration (FDA) in the Nutrition Facts label rule (81 FR 33742 at 33980), “added sugars” are “sugars that are either added during the processing of foods, or are packaged as such. (e.g., a bag of sugar). Added sugars include sugars (free, mono- and disaccharides), sugars from syrups and honey, and sugars from concentrated fruit or vegetable juices that are in excess of what would be expected from the same volume of 100% fruit or vegetable juice of the same type.”

Accordingly, in embodiments, the center 110 may comprise nuts. As used herein, “nuts” is not strictly limited to scientific definitions thereof and may include other plant-based products commonly referred to as nuts, such as, for example, legumes like peanuts (also referred to as groundnuts or goobers). Accordingly, in embodiments, the center 110 of a multilayer edible product 100, 200 may comprise “nuts,” such as tree nuts and legumes. In embodiments, the center may comprise tree nuts such as, for example, almonds, cashews, chestnuts, hazelnuts, and the like. In embodiments, the center may comprise legumes such as, for example, peanuts and walnuts. In some embodiments, the nut-based center comprises almonds or peanuts.

In embodiments where the center comprises nuts, the nuts are pulverized into a desired particle size. As should be understood, the particle size of the pulverized nuts will affect the consistency and overall mouth feel of the center 110 of the multilayer edible product 100, 200. For instance, if the particle size of the nuts is too large, the center will be gritty, have an undesirable mouth feel, and will not melt homogeneously. In embodiments, the nuts may be pulverized by any conventional mechanism, such as grinding, milling, pressing, jet milling, food processing, mortar and pestle, and the like. According to embodiments, the nuts may be pulverized such that a medium particle size distribution, D₅₀, as measured by laser diffraction, is less than or equal to 25.0 μm, such as less than or equal to 22.0 μm, less than or equal to 20.0 μm, less than or equal to 18.0 μm, less than or equal to 15.0 μm, less than or equal to 12.0 μm, less than or equal to 10.0 μm, less than or equal to 8.0 μm, or less than or equal to 5.0 μm. Thus, according to embodiments, the nuts may be pulverized such that a medium particle size distribution, D₅₀, is from greater than or equal to 0.0 μm to less than or equal to 25.0 μm, such as from greater than or equal to 5.0 μm to less than or equal to 22.0 μm, from greater than or equal to 10.0 μm to less than or equal to 20.0 μm, from greater than or equal to 12.0 μm to less than or equal to 18.0 μm, or about 15 μm.

According to embodiments, the nuts may be pulverized such that a particle size distribution, D₉₀, as measured by laser diffraction is less than or equal to 55.0 μm, such as less than or equal to 52.0 μm, less than or equal to 50.0 μm, less than or equal to 48.0 μm, less than or equal to 45.0 μm, less than or equal to 42.0 μm, less than or equal to 40.0 μm, less than or equal to 38.0 μm, or less than or equal to 35.0 μm. Thus, according to embodiments, the nuts may be pulverized such that a particle size distribution, D₉₀, is from greater than or equal to 30.0 μm to less than or equal to 55.0 μm, such as from greater than or equal to 35.0 μm to less than or equal to 52.0 μm, from greater than or equal to 38.0 μm to less than or equal to 50.0 μm, from greater than or equal to 40.0 μm to less than or equal to 48.0 μm, or about 45 μm.

In embodiments where the center 110 comprises pulverized nuts, the center 110 may also comprise other components, such as high-melting temperature fat, and low-temperature melting fat. According to embodiments, the center may be a nut-based center comprising greater than or equal to 60.0 wt % pulverized nuts (as described above), greater than or equal to 5.0 wt % high-melting temperature fat, and greater than or equal to 5.0 wt % low-melting temperature fat. Each of the high-melting temperature fat and low-melting temperature fat will be described in more detail below.

According to embodiments, the center 110 may comprise greater than or equal to 60.0 wt % pulverized nuts, such as greater than or equal to 62.5 wt % pulverized nuts, greater than or equal to 65.0 wt % pulverized nuts, greater than or equal to 67.5 wt % pulverized nuts, greater than or equal to 70.0 wt % pulverized nuts, greater than or equal to 72.5 wt % pulverized nuts, greater than or equal to 75.0 wt % pulverized nuts, greater than or equal to 77.5 wt % pulverized nuts, or greater than or equal to 80.0 wt % pulverized nuts. For each of the above ranges, the maximum content of pulverized nuts present in the center may be, according to embodiments, 90.0 wt %. Accordingly, in embodiments, the content of pulverized nuts in the center 110 may be from greater than or equal to 60.0 wt % to less than or equal to 90.0 wt %, such as from greater than or equal to 62.5 wt % to less than or equal to 90.0 wt %, from greater than or equal to 65.0 wt % to less than or equal to 90.0 wt %, from greater than or equal to 67.5 wt % to less than or equal to 90.0 wt %, from greater than or equal to 70.0 wt % to less than or equal to 70.0 wt %, from greater than or equal to 72.5 wt % to less than or equal to 90.0 wt %, from greater than or equal to 75.0 wt % to less than or equal to 90.0 wt %, from greater than or equal to 77.5 wt % to less than or equal to 90.0 wt %, from greater than or equal to 80.0 wt % to less than or equal to 90.0 wt %, from greater than or equal to 60.0 wt % to less than or equal to 80.0 wt %, such as from greater than or equal to 62.5 wt % to less than or equal to 80.0 wt %, from greater than or equal to 65.0 wt % to less than or equal to 80.0 wt %, from greater than or equal to 67.5 wt % to less than or equal to 80.0 wt %, from greater than or equal to 70.0 wt % to less than or equal to 70.0 wt %, from greater than or equal to 72.5 wt % to less than or equal to 80.0 wt %, from greater than or equal to 75.0 wt % to less than or equal to 80.0 wt %, from greater than or equal to 77.5 wt % to less than or equal to 80.0 wt %, from greater than or equal to 60.0 wt % to less than or equal to 77.5 wt %, such as from greater than or equal to 62.5 wt % to less than or equal to 77.5 wt %, from greater than or equal to 65.0 wt % to less than or equal to 77.5 wt %, from greater than or equal to 67.5 wt % to less than or equal to 77.5 wt %, from greater than or equal to 70.0 wt % to less than or equal to 70.0 wt %, from greater than or equal to 72.5 wt % to less than or equal to 77.5 wt %, from greater than or equal to 75.0 wt % to less than or equal to 77.5 wt %, from greater than or equal to 60.0 wt % to less than or equal to 75.0 wt %, such as from greater than or equal to 62.5 wt % to less than or equal to 75.0 wt %, from greater than or equal to 65.0 wt % to less than or equal to 75.0 wt %, from greater than or equal to 67.5 wt % to less than or equal to 75.0 wt %, from greater than or equal to 70.0 wt % to less than or equal to 70.0 wt %, from greater than or equal to 72.5 wt % to less than or equal to 75.0 wt %, from greater than or equal to 60.0 wt % to less than or equal to 72.5 wt %, such as from greater than or equal to 62.5 wt % to less than or equal to 72.5 wt %, from greater than or equal to 65.0 wt % to less than or equal to 72.5 wt %, from greater than or equal to 67.5 wt % to less than or equal to 72.5 wt %, from greater than or equal to 70.0 wt % to less than or equal to 72.5 wt %, from greater than or equal to 60.0 wt % to less than or equal to 70.0 wt %, such as from greater than or equal to 62.5 wt % to less than or equal to 70.0 wt %, from greater than or equal to 65.0 wt % to less than or equal to 70.0 wt %, from greater than or equal to 67.5 wt % to less than or equal to 70.0 wt %, from greater than or equal to 60.0 wt % to less than or equal to 67.5 wt %, such as from greater than or equal to 62.5 wt % to less than or equal to 67.5 wt %, from greater than or equal to 65.0 wt % to less than or equal to 67.5 wt %, from greater than or equal to 60.0 wt % to less than or equal to 65.0 wt %, such as from greater than or equal to 62.5 wt % to less than or equal to 65.0 wt %, from greater than or equal to 60.0 wt % to less than or equal to 62.5 wt %.

According to embodiments, the center 110 may comprise a high-melting temperature fat. As used herein, a “high-melting temperature fat” means fats with high concentrations of saturated fatty acids and longer hydrocarbon chains. Typically, high-melting temperature fats are typically solid at ambient temperatures and have melting points of greater than or equal to 30° C. The high-melting temperature fats may be naturally existing or be a product of hydrogenation. Fats with trans fatty acids, such as those having a “trans” configuration, may also be included within this definition. The high-melting temperature fat may, according to embodiments, comprise coconut oil, anhydrous milk fat, palm oil (such as, for example, Revel™ A manufactured by Loders Croklaan), chocolate, cocoa butter, fractionated palm oil, double fractionated palm oil, fully hydrogenated coconut palm and palm kernel oils, palm kernel oil, interesterified vegetable oil, partially hydrogenated oil, animal fat, shortening, or combinations thereof. In some embodiments, high-melting fat comprises coconut oil, anhydrous milk fat, palm oil, chocolate, or combinations thereof. As will be discussed in more detail below, controlling the melting point and viscosity of the center 110 allows for a multilayer edible product 100, 200 with a center 110 that is gooey and homogenous when heated by conventional heating, such as microwave, which results in a desirable mouth feel. The high-melting temperature fat can be added in amounts that help to control the viscosity of the center at varying temperatures. According to embodiments, the content of the high-melting temperature fat in the center 110 may be greater than or equal to 5.0 wt %, such as greater than or equal to 7.5 wt %, greater than or equal to 8.0 wt %, greater than or equal to 8.5 wt %, greater than or equal to 9.0 wt %, greater than or equal to 9.5 wt %, greater than or equal to 10.0 wt %, greater than or equal to 10.5 wt %, greater than or equal to 11.0 wt %, greater than or equal to 11.5 wt %, greater than or equal to 12.0 wt %, greater than or equal to 12.5 wt %, greater than or equal to 13.0 wt %, greater than or equal to 13.5 wt %, greater than or equal to 14.0 wt %, greater than or equal to 14.5 wt %, or greater than or equal to 15.0 wt %.

In some embodiments, the maximum content of the high-melting temperature fat in the center 110 may be 20.0 wt %. Accordingly, in embodiments, the content of the high-melting temperature fat in the center 110 may be from greater than or equal to 5.0 wt % to less than or equal to 20.0 wt %, such as from greater than or equal to 6.0 wt % to less than or equal to 20.0 wt %, from greater than or equal to 7.0 wt % to less than or equal to 20.0 wt %, from greater than or equal to 8.0 wt % to less than or equal to 20.0 wt %, from greater than or equal to 9.0 wt % to less than or equal to 20.0 wt %, from greater than or equal to 10.0 wt % to less than or equal to 20.0 wt %, from greater than or equal to 11.0 wt % to less than or equal to 20.0 wt %, from greater than or equal to 12.0 wt % to less than or equal to 20.0 wt %, from greater than or equal to 13.0 wt % to less than or equal to 20.0 wt %, from greater than or equal to 14.0 wt % to less than or equal to 20.0 wt %, from greater than or equal to 15.0 wt % to less than or equal to 20.0 wt %, from greater than or equal to 5.0 wt % to less than or equal to 15.0 wt %, such as from greater than or equal to 6.0 wt % to less than or equal to 15.0 wt %, from greater than or equal to 7.0 wt % to less than or equal to 15.0 wt %, from greater than or equal to 8.0 wt % to less than or equal to 15.0 wt %, from greater than or equal to 9.0 wt % to less than or equal to 15.0 wt %, from greater than or equal to 10.0 wt % to less than or equal to 15.0 wt %, from greater than or equal to 11.0 wt % to less than or equal to 15.0 wt %, from greater than or equal to 12.0 wt % to less than or equal to 15.0 wt %, from greater than or equal to 13.0 wt % to less than or equal to 15.0 wt %, from greater than or equal to 14.0 wt % to less than or equal to 15.0 wt %, from greater than or equal to 5.0 wt % to less than or equal to 14.0 wt %, such as from greater than or equal to 6.0 wt % to less than or equal to 14.0 wt %, from greater than or equal to 7.0 wt % to less than or equal to 14.0 wt %, from greater than or equal to 8.0 wt % to less than or equal to 14.0 wt %, from greater than or equal to 9.0 wt % to less than or equal to 14.0 wt %, from greater than or equal to 10.0 wt % to less than or equal to 14.0 wt %, from greater than or equal to 11.0 wt % to less than or equal to 14.0 wt %, from greater than or equal to 12.0 wt % to less than or equal to 14.0 wt %, from greater than or equal to 13.0 wt % to less than or equal to 14.0 wt %, from greater than or equal to 5.0 wt % to less than or equal to 13.0 wt %, such as from greater than or equal to 6.0 wt % to less than or equal to 13.0 wt %, from greater than or equal to 7.0 wt % to less than or equal to 13.0 wt %, from greater than or equal to 8.0 wt % to less than or equal to 13.0 wt %, from greater than or equal to 9.0 wt % to less than or equal to 13.0 wt %, from greater than or equal to 10.0 wt % to less than or equal to 13.0 wt %, from greater than or equal to 11.0 wt % to less than or equal to 13.0 wt %, from greater than or equal to 12.0 wt % to less than or equal to 13.0 wt %, from greater than or equal to 5.0 wt % to less than or equal to 12.0 wt %, such as from greater than or equal to 6.0 wt % to less than or equal to 12.0 wt %, from greater than or equal to 7.0 wt % to less than or equal to 12.0 wt %, from greater than or equal to 8.0 wt % to less than or equal to 12.0 wt %, from greater than or equal to 9.0 wt % to less than or equal to 12.0 wt %, from greater than or equal to 10.0 wt % to less than or equal to 12.0 wt %, from greater than or equal to 11.0 wt % to less than or equal to 12.0 wt %, from greater than or equal to 5.0 wt % to less than or equal to 11.0 wt %, such as from greater than or equal to 6.0 wt % to less than or equal to 11.0 wt %, from greater than or equal to 7.0 wt % to less than or equal to 11.0 wt %, from greater than or equal to 8.0 wt % to less than or equal to 11.0 wt %, from greater than or equal to 9.0 wt % to less than or equal to 11.0 wt %, from greater than or equal to 10.0 wt % to less than or equal to 11.0 wt %, from greater than or equal to 5.0 wt % to less than or equal to 10.0 wt %, such as from greater than or equal to 6.0 wt % to less than or equal to 10.0 wt %, from greater than or equal to 7.0 wt % to less than or equal to 10.0 wt %, from greater than or equal to 8.0 wt % to less than or equal to 10.0 wt %, from greater than or equal to 9.0 wt % to less than or equal to 10.0 wt %, from greater than or equal to 5.0 wt % to less than or equal to 9.0 wt %, such as from greater than or equal to 6.0 wt % to less than or equal to 9.0 wt %, from greater than or equal to 7.0 wt % to less than or equal to 9.0 wt %, from greater than or equal to 8.0 wt % to less than or equal to 9.0 wt %, from greater than or equal to 5.0 wt % to less than or equal to 8.0 wt %, such as from greater than or equal to 6.0 wt % to less than or equal to 8.0 wt %, from greater than or equal to 7.0 wt % to less than or equal to 8.0 wt %, from greater than or equal to 5.0 wt % to less than or equal to 7.0 wt %, such as from greater than or equal to 6.0 wt % to less than or equal to 7.0 wt %, from greater than or equal to 5.0 wt % to less than or equal to 6.0 wt %.

A low-melting temperature fat may optionally be added to embodiments of the center 110. As used herein, “low-melting temperature fat” means a fat source that is a liquid or liquidus at room temperature. Like, the high-melting temperature fat, the low-melting temperature fat can be added to help control the viscosity of the center at various temperatures. Because the low-melting temperature fat melts at low temperatures, it will lower the viscosity of the center at temperatures above its melting point. In embodiments, the low-melting temperature fat may be selected from vegetable oils, peanut oils, sunflower seed oil, olive oil, soybean oil, canola oil, corn oil, cottonseed oil, high oleic oil varieties, algal oil, and mixtures thereof. As stated above, the low-melting temperature fat is an optional component of the center 110, thus in embodiments disclosed and described herein, the center does not include any low-temperature melting fat. Accordingly, in embodiments, the content of the low-temperature melting fat in the center 110 may be greater than or equal to 0.0 wt %, such as greater than or equal to 2.0 wt %, greater than or equal to 5.0 wt %, greater than or equal to 8.0 wt %, greater than or equal to 10.0 wt %, greater than or equal to 12.0 wt %, or greater than or equal to 15.0 wt %. In some embodiments, the maximum content of the low-melting temperature fat in the center 110 may be 20.0 wt %. Accordingly, in embodiments, the content of the low-temperature melting fat in the center 110 may be from greater than or equal to 0.0 wt % to less than or equal to 20.0 wt %, such as from greater than or equal to 2.0 wt % to less than or equal to 20.0 wt %, from greater than or equal to 5.0 wt % to less than or equal to 20.0 wt %, from greater than or equal to 8.0 wt % to less than or equal to 20.0 wt %, from greater than or equal to 10.0 wt % to less than or equal to 20.0 wt %, from greater than or equal to 12.0 wt % to less than or equal to 20.0 wt %, from greater than or equal to 15.0 wt % to less than or equal to 20.0 wt %, from greater than or equal to 0.0 wt % to less than or equal to 15.0 wt %, such as from greater than or equal to 2.0 wt % to less than or equal to 15.0 wt %, from greater than or equal to 5.0 wt % to less than or equal to 15.0 wt %, from greater than or equal to 8.0 wt % to less than or equal to 15.0 wt %, from greater than or equal to 10.0 wt % to less than or equal to 15.0 wt %, from greater than or equal to 12.0 wt % to less than or equal to 15.0 wt %, from greater than or equal to 0.0 wt % to less than or equal to 12.0 wt %, such as from greater than or equal to 2.0 wt % to less than or equal to 12.0 wt %, from greater than or equal to 5.0 wt % to less than or equal to 12.0 wt %, from greater than or equal to 8.0 wt % to less than or equal to 12.0 wt %, from greater than or equal to 10.0 wt % to less than or equal to 12.0 wt %, from greater than or equal to 0.0 wt % to less than or equal to 10.0 wt %, such as from greater than or equal to 2.0 wt % to less than or equal to 10.0 wt %, from greater than or equal to 5.0 wt % to less than or equal to 10.0 wt %, from greater than or equal to 8.0 wt % to less than or equal to 10.0 wt %, from greater than or equal to 0.0 wt % to less than or equal to 8.0 wt %, such as from greater than or equal to 2.0 wt % to less than or equal to 8.0 wt %, from greater than or equal to 5.0 wt % to less than or equal to 8.0 wt %, from greater than or equal to 0.0 wt % to less than or equal to 5.0 wt %, such as from greater than or equal to 2.0 wt % to less than or equal to 5.0 wt %, from greater than or equal to 0.0 wt % to less than or equal to 2.0 wt %.

The pulverized nuts, high-melting temperature fat, and low-melting temperature fat may be mixed together to form the center 110 by any suitable method. According to embodiments, the pulverized nuts, high-melting temperature fat, and low-melting temperature fat are combined into a vessel and mixed at temperatures sufficient to allow for homogenous mixing of the pulverized nuts, high-melting temperature fat, and low-melting temperature fat. The heating and mixing may be accomplished by conventional techniques and with conventional equipment known in the art. Once the pulverized nuts, high-melting temperature fat, low-melting temperature fat are combined into a homogenous mixture, the mixture is cooled to room temperature and may be formed into the center 110 by any suitable method and mechanism known in the art.

As disclosed above, the content of pulverized nuts, high-melting temperature fat, and low-melting temperature fat in the center 110 may be balanced to control the viscosity of the center 110 at varying temperatures. In addition to controlling the viscosity of the center 110, the content of pulverized nuts, high-melting temperature fat, and low-melting temperature fat in the center 110 may be balanced to control the melting temperature and relaxation time of the center 110. By controlling the viscosity, melting temperature, and relaxation time of the center 110, a center 110 may be formulated so that when the center 110 is heated by conventional heating mechanisms, such as by a microwave, the center 110 turns from semi-solid to a less viscous, gooey center with a good mouth feel.

According to embodiments, the contents of the center 110 may be balanced so that the center 110 has a viscosity less than or equal to 1000 Pa·s at temperatures less than or equal to 50° C., such as less than or equal to 1000 Pa·s at temperatures less than or equal to 48° C., less than or equal to 1000 Pa·s at temperatures less than or equal to 45° C., a viscosity less than or equal to 1000 Pa·s at temperatures less than or equal to 42° C., a viscosity less than or equal to 1000 Pa·s at temperatures less than or equal to 40° C., a viscosity less than or equal to 1000 Pa·s at temperatures less than or equal to 38° C., a viscosity less than or equal to 1000 Pa·s at temperatures less than or equal to 35° C., a viscosity less than or equal to 1000 Pa·s at temperatures less than or equal to 32° C., or a viscosity less than or equal to 1000 Pa·s at temperatures less than or equal to 30° C. According to embodiments, the minimum temperature at which the center 110 has a viscosity less than or equal to 1000 Pa·s is 25° C. Accordingly, in embodiments the contents of the center 110 may be balanced so that the center 110 has a viscosity less than or equal to 1000 Pa·s at temperatures greater than or equal to 25° C. to less than or equal to 50° C., such as a viscosity less than or equal to 1000 Pa·s at temperatures greater than or equal to 25° C. to less than or equal to 48° C., a viscosity less than or equal to 1000 Pa·s at temperatures greater than or equal to 25° C. to less than or equal to 45° C., a viscosity less than or equal to 1000 Pa·s at temperatures greater than or equal to 25° C. to less than or equal to 42° C., a viscosity less than or equal to 1000 Pa·s at temperatures greater than or equal to 25° C. to less than or equal to 40° C., a viscosity less than or equal to 1000 Pa·s at temperatures greater than or equal to 25° C. to less than or equal to 38° C., a viscosity less than or equal to 1000 Pa·s at temperatures greater than or equal to 25° C. to less than or equal to 35° C., a viscosity less than or equal to 1000 Pa·s at temperatures greater than or equal to 25° C. to less than or equal to 32° C., or a viscosity less than or equal to 1000 Pa·s at temperatures greater than or equal to 25° C. to less than or equal to 30° C. In embodiments, the contents of the center 110 may be balanced so that the center 110 has a viscosity less than or equal to 1000 Pa·s at temperatures greater than or equal to 28° C. to less than or equal to 50° C., such as a viscosity less than or equal to 1000 Pa·s at temperatures greater than or equal to 30° C. to less than or equal to 50° C., a viscosity less than or equal to 1000 Pa·s at temperatures greater than or equal to 32° C. to less than or equal to 50° C., a viscosity less than or equal to 1000 Pa·s at temperatures greater than or equal to 35° C. to less than or equal to 50° C., a viscosity less than or equal to 1000 Pa·s at temperatures greater than or equal to 38° C. to less than or equal to 50° C., a viscosity less than or equal to 1000 Pa·s at temperatures greater than or equal to 40° C. to less than or equal to 50° C., a viscosity less than or equal to 1000 Pa·s at temperatures greater than or equal to 42° C. to less than or equal to 50° C., a viscosity less than or equal to 1000 Pa·s at temperatures greater than or equal to 45° C. to less than or equal to 50° C., or a viscosity less than or equal to 1000 Pa·s at temperatures greater than or equal to 48° C. to less than or equal to 50° C. In embodiments, the contents of the center 110 may be balanced so that the center 110 has a viscosity less than or equal to 1000 Pa·s at temperatures greater than or equal to 28° C. to less than or equal to 48° C., such as a viscosity less than or equal to 1000 Pa·s at temperatures greater than or equal to 30° C. to less than or equal to 45° C., a viscosity less than or equal to 1000 Pa·s at temperatures greater than or equal to 32° C. to less than or equal to 42° C., or a viscosity less than or equal to 1000 Pa·s at temperatures greater than or equal to 35° C. to less than or equal to 40° C., as measured by Rheological thermal analysis.

According to embodiments, the contents of the center 110 may be balanced so that the center 110 has a melting temperature of less than or equal to 57° C., such as less than or equal to 55° C., less than or equal to 52° C., less than or equal to 50° C., less than or equal to 48° C., less than or equal to 45° C., less than or equal to 42° C., less than or equal to 40° C., less than or equal to 38° C., or less than or equal to 35° C., less than or equal to 32° C., or less than or equal to 30° C. According to embodiments, the minimum melting temperature may be 28° C. Accordingly, in embodiments, the contents of the center 110 may be balanced so that the center 110 has a melting temperature from greater than or equal to 28° C. to less than or equal to 57° C., such as from greater than or equal to 28° C. to less than or equal to 55° C., from greater than or equal to 28° C. to less than or equal to 52° C., from greater than or equal to 28° C. to less than or equal to 50° C., from greater than or equal to 28° C. to less than or equal to 48° C., from greater than or equal to 28° C. to less than or equal to 45° C., from greater than or equal to 28° C. to less than or equal to 42° C., from greater than or equal to 28° C. to less than or equal to 40° C., from greater than or equal to 28° C. to less than or equal to 38° C., from greater than or equal to 28° C. to less than or equal to 35° C., from greater than or equal to 28° C. to less than or equal to 32° C., or from greater than or equal to 28° C. to less than or equal to 30° C. In embodiments, the contents of the center 110 may be balanced so that the center 110 has a melting temperature from greater than or equal to 30° C. to less than or equal to 57° C., such as from greater than or equal to 32° C. to less than or equal to 57° C., from greater than or equal to 35° C. to less than or equal to 57° C., from greater than or equal to 38° C. to less than or equal to 57° C., from greater than or equal to 40° C. to less than or equal to 57° C., from greater than or equal to 42° C. to less than or equal to 57° C., from greater than or equal to 45° C. to less than or equal to 57° C., from greater than or equal to 48° C. to less than or equal to 57° C., from greater than or equal to 50° C. to less than or equal to 57° C., from greater than or equal to 52° C. to less than or equal to 57° C., or from greater than or equal to 55° C. to less than or equal to 57° C. In embodiments, the contents of the center 110 may be balanced so that the center 110 has a melting temperature from greater than or equal to 30° C. to less than or equal to 55° C., such as from greater than or equal to 32° C. to less than or equal to 52° C., from greater than or equal to 35° C. to less than or equal to 50° C., from greater than or equal to 38° C. to less than or equal to 48° C., or from greater than or equal to 40° C. to less than or equal to 45° C., as measured by Rheological thermal analysis.

According to embodiments, the contents of the center 110 may be balanced so that the center 110 has a relaxation time, at 37° C., of less than or equal to 0.165 seconds, such as less than or equal to 0.160 seconds, less than or equal to 0.155 seconds, less than or equal to 0.150 seconds, less than or equal to 0.145 seconds, less than or equal to 0.140 seconds, less than or equal to 0.135 seconds, less than or equal to 0.130 seconds, or less than or equal to 0.125 seconds. In embodiments, the minimum relaxation time, at 37° C., is 0.120 seconds. Accordingly, in embodiments, the contents of the center 110 may be balanced so that the center 110 has a relaxation time, at 37° C., from greater than or equal to 0.120 seconds to less than or equal to 0.165 seconds, such as from greater than or equal to 0.120 seconds to less than or equal to 0.160 seconds, from greater than or equal to 0.120 seconds to less than or equal to 0.155 seconds, from greater than or equal to 0.120 seconds to less than or equal to 0.150 seconds, from greater than or equal to 0.120 seconds to less than or equal to 0.145 seconds, from greater than or equal to 0.120 seconds to less than or equal to 0.140 seconds, from greater than or equal to 0.120 seconds to less than or equal to 0.135 seconds, from greater than or equal to 0.120 seconds to less than or equal to 0.130 seconds, or from greater than or equal to 0.120 seconds to less than or equal to 0.125 seconds. In embodiments, the contents of the center 110 may be balanced so that the center 110 has a relaxation time, at 37° C., from greater than or equal to 0.125 seconds to less than or equal to 0.165 seconds, such as from greater than or equal to 0.130 seconds to less than or equal to 0.165 seconds, from greater than or equal to 0.135 seconds to less than or equal to 0.165 seconds, from greater than or equal to 0.140 seconds to less than or equal to 0.165 seconds, from greater than or equal to 0.145 seconds to less than or equal to 0.165 seconds, from greater than or equal to 0.150 seconds to less than or equal to 0.165 seconds, from greater than or equal to 0.155 seconds to less than or equal to 0.165 seconds, or from greater than or equal to 0.160 seconds to less than or equal to 0.165 seconds. In embodiments, the contents of the center 110 may be balanced so that the center 110 has a relaxation time, at 37° C., from greater than or equal to 0.130 seconds to less than or equal to 0.160 seconds, such as from greater than or equal to 0.135 seconds to less than or equal to 0.155 seconds, or from greater than or equal to 0.140 seconds to less than or equal to 0.150 seconds, as measured by Rheological thermal analysis.

In addition to pulverized nuts, high-melting temperature fats, and low-melting temperature fats, the composition of the center may further comprise additives such as flavorings and natural, non-sugar based sweeteners, such as monk fruit extract, monk fruit powder, stevia, artificial high-intensity sweeteners, stabilizers (such as, for example, sunflower lecithin and soy lecithin), and the like. Flavorings may include, but are not limited to, nut flavoring and extracts—such as almond flavor, almond extract, peanut flavor, peanut extract—vanilla, cinnamon, and the like. The additives may be included in the composition of the center 110 in amounts less than or equal to 2.0 wt %, such as less than or equal to 1.5 wt %, less than or equal to 1.0 wt %, less than or equal to 0.7 wt %, less than or equal to 0.6 wt %, or less than or equal to 0.5 wt %.

Barrier Layer

As described above, embodiments of a multilayer edible product 100, 200 according to embodiments comprises a barrier layer 120 positioned between the center 110 and the outer layer 130. One function of the barrier layer 120 is to prevent migration of fat and/or moisture from the center 110 to the outer layer 130. Accordingly, the barrier layer 120 of embodiments is formulated to prevent this migration of fat and/or moisture. In addition, the composition of the center according to embodiments disclosed and described herein does not include added sugar. According to embodiments, the barrier layer comprises a source of fat, a hydrophilic powder, and water. In embodiments, the composition of the barrier layer 120 is different from the composition of the center 110 and the composition of the outer layer 130.

As described above, the barrier layer 120 comprises a hydrophilic powder. The hydrophilic powder may, according to embodiments, be flour, salt, fiber, artificial sweeteners, and mixtures thereof. In embodiments, where the hydrophilic powder comprises flour, the flour may be unbleached flour. Fibers that may be included in embodiments of the barrier layer 120 composition include, but are not limited to, inulin, carrageen, agar, and pectin. Natural and artificial sweeteners that may be included in embodiments of the barrier layer 120 composition include, but are not limited to, Allulose, stevia, monk fruit, saccharin, aspartame, sucralose, acesulfame potassium (Ace-K), other artificial sweeteners, and mixtures thereof.

The hydrophilic powder may absorb some of the fat and/or moisture in the center 110, thereby mitigating the migration of fat and/or moisture from the center 110 to the outer layer 130. According to embodiments, the barrier layer 120 comprises greater than or equal to 35.0 wt % hydrophilic powder, such as greater than or equal to 38.0 wt % hydrophilic powder, greater than or equal to 40.0 wt % hydrophilic powder, greater than or equal to 42.0 wt % hydrophilic powder, greater than or equal to 45.0 wt % hydrophilic powder, greater than or equal to 48.0 wt % hydrophilic powder, greater than or equal to 50.0 wt % hydrophilic powder, greater than or equal to 52.0 wt % hydrophilic powder, greater than or equal to 55.0 wt % hydrophilic powder, greater than or equal to 57.0 wt % hydrophilic powder, greater than or equal to 60.0 wt % hydrophilic powder, greater than or equal to 62.0 wt % hydrophilic powder, or greater than or equal to 65.0 wt % hydrophilic powder. In some embodiments, the maximum content of hydrophilic powder in the barrier layer 120 is 75.0 wt %. Accordingly, in embodiments, the content of hydrophilic powder in the barrier layer is from greater than or equal to 35.0 wt % to less than or equal to 75.0 wt %, from greater than or equal to 38.0 wt % to less than or equal to 75.0 wt %, from greater than or equal to 40.0 wt % to less than or equal to 75.0 wt %, from greater than or equal to 40.0 wt % to less than or equal to 75.0 wt %, from greater than or equal to 42.0 wt % to less than or equal to 75.0 wt %, from greater than or equal to 45.0 wt % to less than or equal to 75.0 wt %, from greater than or equal to 48.0 wt % to less than or equal to 75.0 wt %, from greater than or equal to 50.0 wt % to less than or equal to 75.0 wt %, from greater than or equal to 52.0 wt % to less than or equal to 75.0 wt %, from greater than or equal to 55.0 wt % to less than or equal to 75.0 wt %, from greater than or equal to 58.0 wt % to less than or equal to 75.0 wt %, from greater than or equal to 60.0 wt % to less than or equal to 75.0 wt %, from greater than or equal to 62.0 wt % to less than or equal to 75.0 wt %, from greater than or equal to 65.0 wt % to less than or equal to 75.0 wt %, from greater than or equal to 35.0 wt % to less than or equal to 65.0 wt %, from greater than or equal to 38.0 wt % to less than or equal to 65.0 wt %, from greater than or equal to 40.0 wt % to less than or equal to 65.0 wt %, from greater than or equal to 40.0 wt % to less than or equal to 65.0 wt %, from greater than or equal to 42.0 wt % to less than or equal to 65.0 wt %, from greater than or equal to 45.0 wt % to less than or equal to 65.0 wt %, from greater than or equal to 48.0 wt % to less than or equal to 65.0 wt %, from greater than or equal to 50.0 wt % to less than or equal to 65.0 wt %, from greater than or equal to 52.0 wt % to less than or equal to 65.0 wt %, from greater than or equal to 55.0 wt % to less than or equal to 65.0 wt %, from greater than or equal to 58.0 wt % to less than or equal to 65.0 wt %, from greater than or equal to 60.0 wt % to less than or equal to 65.0 wt %, from greater than or equal to 62.0 wt % to less than or equal to 65.0 wt %, from greater than or equal to 35.0 wt % to less than or equal to 62.0 wt %, from greater than or equal to 38.0 wt % to less than or equal to 62.0 wt %, from greater than or equal to 40.0 wt % to less than or equal to 62.0 wt %, from greater than or equal to 40.0 wt % to less than or equal to 62.0 wt %, from greater than or equal to 42.0 wt % to less than or equal to 62.0 wt %, from greater than or equal to 45.0 wt % to less than or equal to 62.0 wt %, from greater than or equal to 48.0 wt % to less than or equal to 62.0 wt %, from greater than or equal to 50.0 wt % to less than or equal to 62.0 wt %, from greater than or equal to 52.0 wt % to less than or equal to 62.0 wt %, from greater than or equal to 55.0 wt % to less than or equal to 62.0 wt %, from greater than or equal to 58.0 wt % to less than or equal to 62.0 wt %, from greater than or equal to 60.0 wt % to less than or equal to 62.0 wt %, from greater than or equal to 35.0 wt % to less than or equal to 60.0 wt %, from greater than or equal to 38.0 wt % to less than or equal to 60.0 wt %, from greater than or equal to 40.0 wt % to less than or equal to 60.0 wt %, from greater than or equal to 40.0 wt % to less than or equal to 60.0 wt %, from greater than or equal to 42.0 wt % to less than or equal to 60.0 wt %, from greater than or equal to 45.0 wt % to less than or equal to 60.0 wt %, from greater than or equal to 48.0 wt % to less than or equal to 60.0 wt %, from greater than or equal to 50.0 wt % to less than or equal to 60.0 wt %, from greater than or equal to 52.0 wt % to less than or equal to 60.0 wt %, from greater than or equal to 55.0 wt % to less than or equal to 60.0 wt %, from greater than or equal to 58.0 wt % to less than or equal to 60.0 wt %, from greater than or equal to 35.0 wt % to less than or equal to 58.0 wt %, from greater than or equal to 38.0 wt % to less than or equal to 58.0 wt %, from greater than or equal to 40.0 wt % to less than or equal to 58.0 wt %, from greater than or equal to 40.0 wt % to less than or equal to 58.0 wt %, from greater than or equal to 42.0 wt % to less than or equal to 58.0 wt %, from greater than or equal to 45.0 wt % to less than or equal to 58.0 wt %, from greater than or equal to 48.0 wt % to less than or equal to 58.0 wt %, from greater than or equal to 50.0 wt % to less than or equal to 58.0 wt %, from greater than or equal to 52.0 wt % to less than or equal to 58.0 wt %, from greater than or equal to 55.0 wt % to less than or equal to 58.0 wt %, from greater than or equal to 35.0 wt % to less than or equal to 55.0 wt %, from greater than or equal to 38.0 wt % to less than or equal to 55.0 wt %, from greater than or equal to 40.0 wt % to less than or equal to 55.0 wt %, from greater than or equal to 40.0 wt % to less than or equal to 55.0 wt %, from greater than or equal to 42.0 wt % to less than or equal to 55.0 wt %, from greater than or equal to 45.0 wt % to less than or equal to 55.0 wt %, from greater than or equal to 48.0 wt % to less than or equal to 55.0 wt %, from greater than or equal to 50.0 wt % to less than or equal to 55.0 wt %, from greater than or equal to 52.0 wt % to less than or equal to 55.0 wt %, from greater than or equal to 35.0 wt % to less than or equal to 52.0 wt %, from greater than or equal to 38.0 wt % to less than or equal to 52.0 wt %, from greater than or equal to 40.0 wt % to less than or equal to 52.0 wt %, from greater than or equal to 40.0 wt % to less than or equal to 52.0 wt %, from greater than or equal to 42.0 wt % to less than or equal to 52.0 wt %, from greater than or equal to 45.0 wt % to less than or equal to 52.0 wt %, from greater than or equal to 48.0 wt % to less than or equal to 52.0 wt %, from greater than or equal to 50.0 wt % to less than or equal to 52.0 wt %, from greater than or equal to 35.0 wt % to less than or equal to 50.0 wt %, from greater than or equal to 38.0 wt % to less than or equal to 50.0 wt %, from greater than or equal to 40.0 wt % to less than or equal to 50.0 wt %, from greater than or equal to 40.0 wt % to less than or equal to 50.0 wt %, from greater than or equal to 42.0 wt % to less than or equal to 50.0 wt %, from greater than or equal to 45.0 wt % to less than or equal to 50.0 wt %, from greater than or equal to 48.0 wt % to less than or equal to 50.0 wt %, from greater than or equal to 35.0 wt % to less than or equal to 48.0 wt %, from greater than or equal to 38.0 wt % to less than or equal to 48.0 wt %, from greater than or equal to 40.0 wt % to less than or equal to 48.0 wt %, from greater than or equal to 40.0 wt % to less than or equal to 48.0 wt %, from greater than or equal to 42.0 wt % to less than or equal to 48.0 wt %, from greater than or equal to 45.0 wt % to less than or equal to 48.0 wt %, from greater than or equal to 35.0 wt % to less than or equal to 45.0 wt %, from greater than or equal to 38.0 wt % to less than or equal to 45.0 wt %, from greater than or equal to 40.0 wt % to less than or equal to 45.0 wt %, from greater than or equal to 40.0 wt % to less than or equal to 45.0 wt %, from greater than or equal to 42.0 wt % to less than or equal to 45.0 wt %, from greater than or equal to 35.0 wt % to less than or equal to 42.0 wt %, from greater than or equal to 38.0 wt % to less than or equal to 42.0 wt %, from greater than or equal to 40.0 wt % to less than or equal to 42.0 wt %, from greater than or equal to 40.0 wt % to less than or equal to 42.0 wt %, from greater than or equal to 35.0 wt % to less than or equal to 40.0 wt %, from greater than or equal to 38.0 wt % to less than or equal to 40.0 wt %, from greater than or equal to 35.0 wt % to less than or equal to 38.0 wt %.

As described above, the barrier layer 120, according to embodiments, comprises a fat source. In some embodiments, the fat source may be selected from palm oil (such as, for example, Revel™ A manufactured by Loders Croklaan), fractionated palm oil, double fractionated palm oil, fully hydrogenated coconut palm and palm kernel oils, palm kernel oil, interesterified vegetable oil, coconut oil, partially hydrogenated oil, animal fat, canola oil, vegetable oil, corn oil, peanut oil, nut oil, and mixtures thereof. In embodiments, the content of the fat source in the barrier layer 120 may be greater than or equal to 5.0 wt %, such as greater than or equal to 8.0 wt %, greater than or equal to 10.0 wt %, greater than or equal to 12.0 wt %, greater than or equal to 15.0 wt %, greater than or equal to 18.0 wt %, greater than or equal to 20.0 wt %, greater than or equal to 22.0 wt %, greater than or equal to 25.0 wt %, greater than or equal to 27.0 wt %, or greater than or equal to 30.0 wt %. In embodiments, the maximum content of the fat source in the barrier layer 120 is 35.0 wt %. Accordingly, in some embodiments, the content of the fat source in the barrier layer 120 is from greater than or equal to 5.0 wt % to less than or equal to 35.0 wt %, such as from greater than or equal to 8.0 wt % to less than or equal to 35.0 wt %, from greater than or equal to 10.0 wt % to less than or equal to 35.0 wt %, from greater than or equal to 12.0 wt % to less than or equal to 35.0 wt %, from greater than or equal to 15.0 wt % to less than or equal to 35.0 wt %, from greater than or equal to 18.0 wt % to less than or equal to 35.0 wt %, from greater than or equal to 20.0 wt % to less than or equal to 35.0 wt %, from greater than or equal to 22.0 wt % to less than or equal to 35.0 wt %, from greater than or equal to 25.0 wt % to less than or equal to 35.0 wt %, from greater than or equal to 28.0 wt % to less than or equal to 35.0 wt %, from greater than or equal to 30.0 wt % to less than or equal to 35.0 wt %, from greater than or equal to 5.0 wt % to less than or equal to 30.0 wt %, from greater than or equal to 8.0 wt % to less than or equal to 30.0 wt %, from greater than or equal to 10.0 wt % to less than or equal to 30.0 wt %, from greater than or equal to 12.0 wt % to less than or equal to 30.0 wt %, from greater than or equal to 15.0 wt % to less than or equal to 30.0 wt %, from greater than or equal to 18.0 wt % to less than or equal to 30.0 wt %, from greater than or equal to 20.0 wt % to less than or equal to 30.0 wt %, from greater than or equal to 22.0 wt % to less than or equal to 30.0 wt %, from greater than or equal to 25.0 wt % to less than or equal to 30.0 wt %, from greater than or equal to 28.0 wt % to less than or equal to 30.0 wt %, from greater than or equal to 5.0 wt % to less than or equal to 28.0 wt %, from greater than or equal to 8.0 wt % to less than or equal to 28.0 wt %, from greater than or equal to 10.0 wt % to less than or equal to 28.0 wt %, from greater than or equal to 12.0 wt % to less than or equal to 28.0 wt %, from greater than or equal to 15.0 wt % to less than or equal to 28.0 wt %, from greater than or equal to 18.0 wt % to less than or equal to 28.0 wt %, from greater than or equal to 20.0 wt % to less than or equal to 28.0 wt %, from greater than or equal to 22.0 wt % to less than or equal to 28.0 wt %, from greater than or equal to 25.0 wt % to less than or equal to 28.0 wt %, from greater than or equal to 5.0 wt % to less than or equal to 25.0 wt %, from greater than or equal to 8.0 wt % to less than or equal to 25.0 wt %, from greater than or equal to 10.0 wt % to less than or equal to 25.0 wt %, from greater than or equal to 12.0 wt % to less than or equal to 25.0 wt %, from greater than or equal to 15.0 wt % to less than or equal to 25.0 wt %, from greater than or equal to 18.0 wt % to less than or equal to 25.0 wt %, from greater than or equal to 20.0 wt % to less than or equal to 25.0 wt %, from greater than or equal to 22.0 wt % to less than or equal to 25.0 wt %, from greater than or equal to 5.0 wt % to less than or equal to 22.0 wt %, from greater than or equal to 8.0 wt % to less than or equal to 22.0 wt %, from greater than or equal to 10.0 wt % to less than or equal to 22.0 wt %, from greater than or equal to 12.0 wt % to less than or equal to 22.0 wt %, from greater than or equal to 15.0 wt % to less than or equal to 22.0 wt %, from greater than or equal to 18.0 wt % to less than or equal to 22.0 wt %, from greater than or equal to 20.0 wt % to less than or equal to 22.0 wt %, from greater than or equal to 5.0 wt % to less than or equal to 20.0 wt %, from greater than or equal to 8.0 wt % to less than or equal to 20.0 wt %, from greater than or equal to 10.0 wt % to less than or equal to 20.0 wt %, from greater than or equal to 12.0 wt % to less than or equal to 20.0 wt %, from greater than or equal to 15.0 wt % to less than or equal to 20.0 wt %, from greater than or equal to 18.0 wt % to less than or equal to 20.0 wt %, from greater than or equal to 5.0 wt % to less than or equal to 18.0 wt %, from greater than or equal to 8.0 wt % to less than or equal to 18.0 wt %, from greater than or equal to 10.0 wt % to less than or equal to 18.0 wt %, from greater than or equal to 12.0 wt % to less than or equal to 18.0 wt %, from greater than or equal to 15.0 wt % to less than or equal to 18.0 wt %, from greater than or equal to 5.0 wt % to less than or equal to 15.0 wt %, from greater than or equal to 8.0 wt % to less than or equal to 15.0 wt %, from greater than or equal to 10.0 wt % to less than or equal to 15.0 wt %, from greater than or equal to 12.0 wt % to less than or equal to 15.0 wt %, from greater than or equal to 5.0 wt % to less than or equal to 12.0 wt %, from greater than or equal to 8.0 wt % to less than or equal to 12.0 wt %, from greater than or equal to 10.0 wt % to less than or equal to 12.0 wt %, from greater than or equal to 5.0 wt % to less than or equal to 10.0 wt %, from greater than or equal to 8.0 wt % to less than or equal to 10.0 wt %. According to embodiments, the fat source may be entirely high-melting temperature fats, entirely low-melting temperature fats, or a mixture of high-melting temperature fats and low-melting temperature fats.

The fat source may include high-melting temperature fats and low-melting temperature fats. The high-melting temperature fat may, according to embodiments, comprise coconut oil, anhydrous milk fat, palm oil (such as, for example, Revel™ A manufactured by Loders Croklaan), chocolate, cocoa butter, fractionated palm oil, double fractionated palm oil, fully hydrogenated coconut palm and palm kernel oils, palm kernel oil, interesterified vegetable oil, partially hydrogenated oil, animal fat, shortening, or combinations thereof. In embodiments, the barrier layer 120 comprises from greater than or equal to 2.0 wt % high-melting temperature fats, such as greater than or equal to 5.0 wt %, greater than or equal to 8.0 wt %, greater than or equal to 10.0 wt %, or greater than or equal to 12.0 wt %. In embodiments, the maximum amount of high-melting temperature fat in the barrier layer 120 is about 15.0 wt %. Accordingly, in embodiments, the barrier layer may include high-melting temperature fats in amounts from greater than or equal to 2.0 wt % to less than or equal to 15.0 wt %, such as from greater than or equal to 5.0 wt % to less than or equal to 15.0 wt %, from greater than or equal to 8.0 wt % to less than or equal to 15.0 wt %, from greater than or equal to 10.0 wt % to less than or equal to 15.0 wt %, from greater than or equal to 12.0 wt % to less than or equal to 15.0 wt %, from greater than or equal to 2.0 wt % to less than or equal to 12.0 wt %, from greater than or equal to 5.0 wt % to less than or equal to 12.0 wt %, from greater than or equal to 8.0 wt % to less than or equal to 12.0 wt %, from greater than or equal to 10.0 wt % to less than or equal to 12.0 wt %, from greater than or equal to 2.0 wt % to less than or equal to 10.0 wt %, from greater than or equal to 5.0 wt % to less than or equal to 10.0 wt %, from greater than or equal to 8.0 wt % to less than or equal to 10.0 wt %, from greater than or equal to 2.0 wt % to less than or equal to 8.0 wt %, from greater than or equal to 5.0 wt % to less than or equal to 8.0 wt %, from greater than or equal to 2.0 wt % to less than or equal to 5.0 wt.

Low-melting temperature fats may be selected from vegetable oils, peanut oils, sunflower seed oil, olive oil, soybean oil, canola oil, corn oil, cottonseed oil, high oleic oil varieties, algal oil, and mixtures thereof. In embodiments, the barrier layer 120 comprises from greater than or equal to 2.0 wt % low-melting temperature fats, such as greater than or equal to 5.0 wt %, greater than or equal to 8.0 wt %, greater than or equal to 10.0 wt %, or greater than or equal to 12.0 wt %. In embodiments, the maximum amount of low-melting temperature fat in the barrier layer 120 is about 15.0 wt %. Accordingly, in embodiments, the barrier layer may include low-melting temperature fats in amounts from greater than or equal to 2.0 wt % to less than or equal to 15.0 wt %, such as from greater than or equal to 5.0 wt % to less than or equal to 15.0 wt %, from greater than or equal to 8.0 wt % to less than or equal to 15.0 wt %, from greater than or equal to 10.0 wt % to less than or equal to 15.0 wt %, from greater than or equal to 12.0 wt % to less than or equal to 15.0 wt %, from greater than or equal to 2.0 wt % to less than or equal to 12.0 wt %, from greater than or equal to 5.0 wt % to less than or equal to 12.0 wt %, from greater than or equal to 8.0 wt % to less than or equal to 12.0 wt %, from greater than or equal to 10.0 wt % to less than or equal to 12.0 wt %, from greater than or equal to 2.0 wt % to less than or equal to 10.0 wt %, from greater than or equal to 5.0 wt % to less than or equal to 10.0 wt %, from greater than or equal to 8.0 wt % to less than or equal to 10.0 wt %, from greater than or equal to 2.0 wt % to less than or equal to 8.0 wt %, from greater than or equal to 5.0 wt % to less than or equal to 8.0 wt %, from greater than or equal to 2.0 wt % to less than or equal to 5.0 wt.

As described above, in embodiments, the barrier layer 120 comprises water. The content of the water in the barrier layer 120, according to embodiments, may be greater than 0.0 wt %, such as greater than or equal to 1.0 wt %, greater than or equal to 2.0 wt %, greater than or equal to 3.0 wt %, greater than or equal to 4.0 wt %, or greater than or equal to 5.0 wt %. In embodiments, the maximum content of water in the barrier layer 120 is 10.0 wt %. Accordingly, in embodiments, the content of water in the barrier layer 120 is from greater than 0.0 wt % to less than or equal to 10.0 wt %, such as from greater than or equal to 1.0 wt % to less than or equal to 10.0 wt %, from greater than or equal to 2.0 wt % to less than or equal to 10.0 wt %, from greater than or equal to 3.0 wt % to less than or equal to 10.0 wt %, from greater than or equal to 4.0 wt % to less than or equal to 10.0 wt %, from greater than or equal to 5.0 wt % to less than or equal to 10.0 wt %, from greater than or equal to 6.0 wt % to less than or equal to 10.0 wt %, from greater than or equal to 7.0 wt % to less than or equal to 10.0 wt %, from greater than or equal to 8.0 wt % to less than or equal to 10.0 wt %, from greater than or equal to 9.0 wt % to less than or equal to 10.0 wt %, from greater than 0.0 wt % to less than or equal to 9.0 wt %, from greater than or equal to 1.0 wt % to less than or equal to 9.0 wt %, from greater than or equal to 2.0 wt % to less than or equal to 9.0 wt %, from greater than or equal to 3.0 wt % to less than or equal to 9.0 wt %, from greater than or equal to 4.0 wt % to less than or equal to 9.0 wt %, from greater than or equal to 5.0 wt % to less than or equal to 9.0 wt %, from greater than or equal to 6.0 wt % to less than or equal to 9.0 wt %, from greater than or equal to 7.0 wt % to less than or equal to 9.0 wt %, from greater than or equal to 8.0 wt % to less than or equal to 9.0 wt %, from greater than 0.0 wt % to less than or equal to 8.0 wt %, from greater than or equal to 1.0 wt % to less than or equal to 8.0 wt %, from greater than or equal to 2.0 wt % to less than or equal to 8.0 wt %, from greater than or equal to 3.0 wt % to less than or equal to 8.0 wt %, from greater than or equal to 4.0 wt % to less than or equal to 8.0 wt %, from greater than or equal to 5.0 wt % to less than or equal to 8.0 wt %, from greater than or equal to 6.0 wt % to less than or equal to 8.0 wt %, from greater than or equal to 7.0 wt % to less than or equal to 8.0 wt %, from greater than 0.0 wt % to less than or equal to 7.0 wt %, from greater than or equal to 1.0 wt % to less than or equal to 7.0 wt %, from greater than or equal to 2.0 wt % to less than or equal to 7.0 wt %, from greater than or equal to 3.0 wt % to less than or equal to 7.0 wt %, from greater than or equal to 4.0 wt % to less than or equal to 7.0 wt %, from greater than or equal to 5.0 wt % to less than or equal to 7.0 wt %, from greater than or equal to 6.0 wt % to less than or equal to 7.0 wt %, from greater than 0.0 wt % to less than or equal to 6.0 wt %, from greater than or equal to 1.0 wt % to less than or equal to 6.0 wt %, from greater than or equal to 2.0 wt % to less than or equal to 6.0 wt %, from greater than or equal to 3.0 wt % to less than or equal to 6.0 wt %, from greater than or equal to 4.0 wt % to less than or equal to 6.0 wt %, from greater than or equal to 5.0 wt % to less than or equal to 6.0 wt %, from greater than 0.0 wt % to less than or equal to 5.0 wt %, from greater than or equal to 1.0 wt % to less than or equal to 5.0 wt %, from greater than or equal to 2.0 wt % to less than or equal to 5.0 wt %, from greater than or equal to 3.0 wt % to less than or equal to 5.0 wt %, from greater than or equal to 4.0 wt % to less than or equal to 5.0 wt %, from greater than 0.0 wt % to less than or equal to 4.0 wt %, from greater than or equal to 1.0 wt % to less than or equal to 4.0 wt %, from greater than or equal to 2.0 wt % to less than or equal to 4.0 wt %, from greater than or equal to 3.0 wt % to less than or equal to 4.0 wt %, from greater than 0.0 wt % to less than or equal to 3.0 wt %, from greater than or equal to 1.0 wt % to less than or equal to 3.0 wt %, from greater than or equal to 2.0 wt % to less than or equal to 3.0 wt %, from greater than 0.0 wt % to less than or equal to 2.0 wt %, from greater than or equal to 1.0 wt % to less than or equal to 2.0 wt %, from greater than 0.0 wt % to less than or equal to 1.0 wt %.

In embodiments, the barrier layer 120 comprises glycerin in amounts of greater than 10.0 wt %, such as greater than 12.0 wt %, greater than 15.0 wt %, greater than 18.0 wt %, greater than 20.0 wt %, greater than 22.0 wt %, greater than 25.0 wt %, greater than 28.0 wt %, greater than 30.0 wt %, greater than 32.0 wt %, or greater than 35.0 wt %. According to embodiments, the maximum amount of glycerin in the barrier layer 120 is 40.0 wt %. Accordingly, in embodiments, the barrier layer 120 comprises glycerin in amounts from greater than or equal to 10.0 wt % to less than or equal to 40.0 wt %, such as from greater than or equal to 12.0 wt % to less than or equal to 40.0 wt %, from greater than or equal to 15.0 wt % to less than or equal to 40.0 wt %, from greater than or equal to 18.0 wt % to less than or equal to 40.0 wt %, from greater than or equal to 20.0 wt % to less than or equal to 40.0 wt %, from greater than or equal to 22.0 wt % to less than or equal to 40.0 wt %, from greater than or equal to 25.0 wt % to less than or equal to 40.0 wt %, from greater than or equal to 28.0 wt % to less than or equal to 40.0 wt %, from greater than or equal to 30.0 wt % to less than or equal to 40.0 wt %, from greater than or equal to 32.0 wt % to less than or equal to 40.0 wt %, from greater than or equal to 35.0 wt % to less than or equal to 40.0 wt %, from greater than or equal to 10.0 wt % to less than or equal to 35.0 wt %, from greater than or equal to 12.0 wt % to less than or equal to 35.0 wt %, from greater than or equal to 15.0 wt % to less than or equal to 35.0 wt %, from greater than or equal to 18.0 wt % to less than or equal to 35.0 wt %, from greater than or equal to 20.0 wt % to less than or equal to 35.0 wt %, from greater than or equal to 22.0 wt % to less than or equal to 35.0 wt %, from greater than or equal to 25.0 wt % to less than or equal to 35.0 wt %, from greater than or equal to 28.0 wt % to less than or equal to 35.0 wt %, from greater than or equal to 30.0 wt % to less than or equal to 35.0 wt %, from greater than or equal to 32.0 wt % to less than or equal to 35.0 wt %, from greater than or equal to 10.0 wt % to less than or equal to 32.0 wt %, from greater than or equal to 12.0 wt % to less than or equal to 32.0 wt %, from greater than or equal to 15.0 wt % to less than or equal to 32.0 wt %, from greater than or equal to 18.0 wt % to less than or equal to 32.0 wt %, from greater than or equal to 20.0 wt % to less than or equal to 32.0 wt %, from greater than or equal to 22.0 wt % to less than or equal to 32.0 wt %, from greater than or equal to 25.0 wt % to less than or equal to 32.0 wt %, from greater than or equal to 28.0 wt % to less than or equal to 32.0 wt %, from greater than or equal to 30.0 wt % to less than or equal to 32.0 wt %, from greater than or equal to 10.0 wt % to less than or equal to 30.0 wt %, from greater than or equal to 12.0 wt % to less than or equal to 30.0 wt %, from greater than or equal to 15.0 wt % to less than or equal to 30.0 wt %, from greater than or equal to 18.0 wt % to less than or equal to 30.0 wt %, from greater than or equal to 20.0 wt % to less than or equal to 30.0 wt %, from greater than or equal to 22.0 wt % to less than or equal to 30.0 wt %, from greater than or equal to 25.0 wt % to less than or equal to 30.0 wt %, from greater than or equal to 28.0 wt % to less than or equal to 30.0 wt %, from greater than or equal to 10.0 wt % to less than or equal to 28.0 wt %, from greater than or equal to 12.0 wt % to less than or equal to 28.0 wt %, from greater than or equal to 15.0 wt % to less than or equal to 28.0 wt %, from greater than or equal to 18.0 wt % to less than or equal to 28.0 wt %, from greater than or equal to 20.0 wt % to less than or equal to 28.0 wt %, from greater than or equal to 22.0 wt % to less than or equal to 28.0 wt %, from greater than or equal to 25.0 wt % to less than or equal to 28.0 wt %, from greater than or equal to 10.0 wt % to less than or equal to 25.0 wt %, from greater than or equal to 12.0 wt % to less than or equal to 25.0 wt %, from greater than or equal to 15.0 wt % to less than or equal to 25.0 wt %, from greater than or equal to 18.0 wt % to less than or equal to 25.0 wt %, from greater than or equal to 20.0 wt % to less than or equal to 25.0 wt %, from greater than or equal to 22.0 wt % to less than or equal to 25.0 wt %, from greater than or equal to 10.0 wt % to less than or equal to 22.0 wt %, from greater than or equal to 12.0 wt % to less than or equal to 22.0 wt %, from greater than or equal to 15.0 wt % to less than or equal to 22.0 wt %, from greater than or equal to 18.0 wt % to less than or equal to 22.0 wt %, from greater than or equal to 20.0 wt % to less than or equal to 22.0 wt %, from greater than or equal to 10.0 wt % to less than or equal to 20.0 wt %, from greater than or equal to 12.0 wt % to less than or equal to 20.0 wt %, from greater than or equal to 15.0 wt % to less than or equal to 20.0 wt %, from greater than or equal to 18.0 wt % to less than or equal to 20.0 wt %, from greater than or equal to 10.0 wt % to less than or equal to 18.0 wt %, from greater than or equal to 12.0 wt % to less than or equal to 18.0 wt %, from greater than or equal to 15.0 wt % to less than or equal to 18.0 wt %, from greater than or equal to 10.0 wt % to less than or equal to 15.0 wt %, from greater than or equal to 12.0 wt % to less than or equal to 15.0 wt %, from greater than or equal to 10.0 wt % to less than or equal to 12.0 wt %.

In one or more embodiments, the barrier layer 120 may include an artificial or natural sweetener, such as, for example, Allulose, stevia, sucralose, tagatose, inulin, sucralose, Ace-K, aspartame, saccharine, monk fruit concentrate, monk fruit extract, and mixtures thereof. The barrier layer 120, according to embodiments, may contain an artificial sweetener in amounts of greater than or equal to 0.0 wt %, such as greater than or equal to 2.0 wt %, greater than or equal to 5.0 wt %, greater than or equal to 8.0 wt %, greater than or equal to 10.0 wt %, greater than or equal to 12.0 wt %, greater than or equal to 15.0 wt %. In embodiments, the barrier layer 120 may comprise artificial sweetener in a maximum amount of 20.0 wt %. Accordingly, in embodiments, the barrier layer may comprise an amount of artificial sweetener from greater than or equal to 0.0 wt % to less than or equal to 20.0 wt %, such as from greater than or equal to 2.0 wt % to less than or equal to 20.0 wt %, greater than or equal to 5.0 wt % to less than or equal to 20.0 wt %, greater than or equal to 8.0 wt % to less than or equal to 20.0 wt %, greater than or equal to 10.0 wt % to less than or equal to 20.0 wt %, greater than or equal to 12.0 wt % to less than or equal to 20.0 wt %, greater than or equal to 15.0 wt % to less than or equal to 20.0 wt %, from greater than or equal to 0.0 wt % to less than or equal to 15.0 wt %, from greater than or equal to 2.0 wt % to less than or equal to 15.0 wt %, greater than or equal to 5.0 wt % to less than or equal to 15.0 wt %, greater than or equal to 8.0 wt % to less than or equal to 15.0 wt %, greater than or equal to 10.0 wt % to less than or equal to 15.0 wt %, greater than or equal to 12.0 wt % to less than or equal to 15.0 wt %, from greater than or equal to 0.0 wt % to less than or equal to 12.0 wt %, from greater than or equal to 2.0 wt % to less than or equal to 12.0 wt %, greater than or equal to 5.0 wt % to less than or equal to 12.0 wt %, greater than or equal to 8.0 wt % to less than or equal to 12.0 wt %, greater than or equal to 10.0 wt % to less than or equal to 12.0 wt %, from greater than or equal to 0.0 wt % to less than or equal to 10.0 wt %, from greater than or equal to 2.0 wt % to less than or equal to 10.0 wt %, greater than or equal to 5.0 wt % to less than or equal to 10.0 wt %, greater than or equal to 8.0 wt % to less than or equal to 10.0 wt %, from greater than or equal to 0.0 wt % to less than or equal to 8.0 wt %, from greater than or equal to 2.0 wt % to less than or equal to 8.0 wt %, greater than or equal to 5.0 wt % to less than or equal to 8.0 wt %, from greater than or equal to 0.0 wt % to less than or equal to 5.0 wt %, from greater than or equal to 2.0 wt % to less than or equal to 5.0 wt %, from greater than or equal to 0.0 wt % to less than or equal to 2.0 wt %.

According to embodiments, the barrier layer 120 may, optionally, comprise one or more additional components, such as, artificial or natural flavor (liquid or powder), colorants (such as FD&C colors), acidulants (such as granular citric acid, malic acid), molasses, preservatives (such as sodium benzoate). According to embodiments, the content of the one or more additional components may be greater than or equal to 0.0 wt %, such as greater than or equal to 2.0 wt %, greater than or equal to 5.0 wt %, or greater than or equal to 8.0 wt %. In embodiments, the maximum content of the one or more additional component in the barrier layer 120 is 10.0 wt %. Accordingly, in some embodiments, the content of the one or more additional components in the barrier layer 120 is from greater than or equal to 0.0 wt % to less than or equal to 10.0 wt %, such as from greater than or equal to 2.0 wt % to less than or equal to 10.0 wt %, from greater than or equal to 5.0 wt % to less than or equal to 10.0 wt %, from greater than or equal to 8.0 wt % to less than or equal to 10.0 wt %, from greater than or equal to 0.0 wt % to less than or equal to 8.0 wt %, from greater than or equal to 2.0 wt % to less than or equal to 8.0 wt %, from greater than or equal to 5.0 wt % to less than or equal to 8.0 wt %, from greater than or equal to 0.0 wt % to less than or equal to 5.0 wt %, from greater than or equal to 2.0 wt % to less than or equal to 5.0 wt %, from greater than or equal to 0.0 wt % to less than or equal to 2.0 wt %. It should be understood that the above ranges are weight percentages of all additional components (such as, for example, the sum of sweeteners, flavors, and colorants) relative the total composition of the barrier layer.

The hydrophilic powder, fat source, water, glycerin, and/or one or more additional components may be mixed together to form the barrier layer 120 by any suitable method. According to embodiments, the hydrophilic powder, fat source, water, glycerin, and/or one or more additional components are combined into a vessel and mixed at temperatures sufficient to allow for homogenous mixing of hydrophilic powder, fat source, water, glycerin, and/or one or more additional components. The heating and mixing may be accomplished by conventional techniques and with conventional equipment known in the art. Once hydrophilic powder, fat source, water, glycerin, and/or one or more additional components are combined into a homogenous mixture, the mixture is cooled to room temperature. Equipment that can be used for mixing, according to embodiments, includes Hobart mixers, scraped surface mixers and agitators.

Outer Layer

The composition of the outer layer 130 of the multilayer edible product 100, 200 is not particularly limited as long as it has a fat content that is either greater than or less than the fat content of the center 110 and/or a water activity that is either greater than or less than the water activity of the center 110. The outer layer 130 according to embodiments disclosed and described herein, the outer layer does not include added sugar. According to embodiments, the outer layer may comprise granola, breading, crumbs, or dough. The outer layer 130 may be produced by any conventional method or equipment.

Multilayer Edible Product

As described above, and with reference to FIG. 1, the multilayer edible product 100 comprises a center 110, a barrier layer 120 directly encompassing the center 110, and an outer layer 130 directly encompassing the barrier layer 120 and indirectly encompassing the center 110. This multilayer edible product 100 may be formed into a layer structure using the center 110, barrier layer 120, and outer layer 130 described above. The multilayer edible product 100 may be produced by any suitable method or equipment that is capable of forming the multilayer product. According to some embodiments, the multilayer edible product 100 may be formed by co-extrusion, such as, for example, triple extrusion.

Co-extrusion processes according to embodiments comprise simultaneous extruding the layers of the multilayer edible product 100. For example, and according to embodiments, the co-extrusion process, such as, for example, triple extrusion, comprises loading the center composition, the barrier layer composition, and the outer layer composition into a co-extrusion machine, such as, for example, a triple extrusion machine. The center composition, the barrier layer composition, and the outer layer composition should each have a viscosity and flow rate such that each of the center composition, the barrier layer composition, and the outer layer composition can be extruded by the co-extrusion machine. In this regard, the center composition, the barrier layer composition, and the outer layer composition may require heating to reach the desired viscosity for co-extrusion. It should be understood that the center composition, the barrier layer composition, and the outer layer composition may be heated, either simultaneously or individually to temperatures that permit the center composition, the barrier layer composition, and the outer layer composition to be co-extruded.

Once the center composition, the barrier layer composition, and the outer layer composition are at the appropriate viscosity and flow rate so that they may be co-extruded, the center composition, the barrier layer composition, and the outer layer composition are expelled from the co-extrusion machine via a co-extrusion nozzle or similar device. The co-extrusion nozzle has three separate outlets; one each for the center composition, the barrier layer composition, and the outer layer composition. The first and center-most outlet of the co-extrusion nozzle expels the center composition. The second outlet of the co-extrusion nozzle is annular and positioned outside of the first outlet of the co-extrusion nozzle. The second outlet of the co-extrusion nozzle expels the barrier layer. The third outlet is of the co-extrusion nozzle is annular and position outside of the second outlet of the co-extrusion nozzle—and, therefore also outside of the first outlet of the co-extrusion nozzle. The third outlet of the co-extrusion nozzle expels the outer layer composition. Using such a co-extrusion nozzle provides a multilayer edible product 100 as shown in FIG. 1.

It should be understood that the physical dimensions of the first outlet, the second outlet, and the third outlet of the co-extrusion nozzle will roughly correlate to the dimensions of the center 110, the barrier layer 120, and the outer layer 130, respectively, of the multilayer edible product 100. The dimensions of the center 110 and the outer layer 130 are not particularly limited; the thickness t of the barrier layer 120 may affect the ability of the barrier layer to prevent migration of fat and/or moisture from the center 110 to the outer layer 130. Accordingly, in embodiments, the thickness of the barrier layer may be selected to achieve the desired prevention of fat and/or moisture from the center 110 to the outer layer 130.

In embodiments, the thickness of the barrier layer 120 is less than or equal to 1.00 mm, such as less than or equal to 0.90 mm, less than or equal to 0.80 mm, less than or equal to 0.70 mm, less than or equal to 0.60 mm, less than or equal to 0.50 mm, less than or equal to 0.40 mm, less than or equal to 0.30 mm, less than or equal to 0.20 mm, or less than or equal to 0.10 mm. In embodiments, the minimum thickness of the barrier layer 120 is 0.02 mm. Accordingly, in some embodiments, the thickness of the barrier layer 120 is from greater than or equal to 0.02 mm to less than or equal to 1.00 mm, such as from greater than or equal to 0.02 mm to less than or equal to 0.90 mm, from greater than or equal to 0.02 mm to less than or equal to 0.80 mm, from greater than or equal to 0.02 mm to less than or equal to 0.70 mm, from greater than or equal to 0.02 mm to less than or equal to 0.60 mm, from greater than or equal to 0.02 mm to less than or equal to 0.50 mm, from greater than or equal to 0.02 mm to less than or equal to 0.40 mm, from greater than or equal to 0.02 mm to less than or equal to 0.30 mm, from greater than or equal to 0.02 mm to less than or equal to 0.20 mm, from greater than or equal to 0.02 mm to less than or equal to 0.10 mm, or from greater than or equal to 0.02 mm to less than or equal to 0.05 mm. In embodiments, the thickness of the barrier layer 120 is from greater than or equal to 0.05 mm to less than or equal to 1.00 mm, such as from greater than or equal to 0.10 mm to less than or equal to 1.00 mm, from greater than or equal to 0.20 mm to less than or equal to 1.00 mm, from greater than or equal to 0.30 mm to less than or equal to 1.00 mm, from greater than or equal to 0.40 mm to less than or equal to 1.00 mm, from greater than or equal to 0.50 mm to less than or equal to 1.00 mm, from greater than or equal to 0.60 mm to less than or equal to 1.00 mm, from greater than or equal to 0.70 mm to less than or equal to 1.00 mm, from greater than or equal to 0.80 mm to less than or equal to 1.00 mm, or from greater than or equal to 0.90 mm to less than or equal to 1.00 mm. In embodiments, the thickness of the barrier layer 120 is from greater than or equal to 0.05 mm to less than or equal to 0.90 mm, such as from greater than or equal to 0.10 mm to less than or equal to 0.80 mm, from greater than or equal to 0.20 mm to less than or equal to 0.70 mm, from greater than or equal to 0.30 mm to less than or equal to 0.60 mm, or from greater than or equal to 0.40 mm to less than or equal to 0.50 mm.

In embodiments, the thickness of the barrier layer is greater than or equal to 1.00 mm, such as greater than or equal to 1.25 mm, greater than or equal to 1.50 mm, greater than or equal to 1.75 mm, greater than or equal to 2.00 mm, greater than or equal to 2.25 mm, greater than or equal to 2.50 mm, greater than or equal to 2.75 mm, greater than or equal to 3.00 mm, greater than or equal to 3.25 mm, greater than or equal to 3.50 mm, greater than or equal to 3.75 mm, greater than or equal to 4.00 mm, greater than or equal to 4.25 mm, greater than or equal to 4.50 mm, or greater than or equal to 4.75 mm. In embodiments, the maximum thickness of the barrier layer 120 is 5.00 mm. Accordingly, in some embodiments, the thickness of the barrier layer is from greater than or equal to 1.00 mm to less than or equal to 5.00 mm, such as from greater than or equal to 1.25 mm to less than or equal to 5.00 mm, from greater than or equal to 1.50 mm to less than or equal to 5.00 mm, from greater than or equal to 1.75 mm to less than or equal to 5.00 mm, from greater than or equal to 2.00 mm to less than or equal to 5.00 mm, from greater than or equal to 2.25 mm to less than or equal to 5.00 mm, from greater than or equal to 2.50 mm to less than or equal to 5.00 mm, from greater than or equal to 2.75 mm to less than or equal to 5.00 mm, from greater than or equal to 3.00 mm to less than or equal to 5.00 mm, from greater than or equal to 3.25 mm to less than or equal to 5.00 mm, from greater than or equal to 3.50 mm to less than or equal to 5.00 mm, from greater than or equal to 3.75 mm to less than or equal to 5.00 mm, from greater than or equal to 4.00 mm to less than or equal to 5.00 mm, from greater than or equal to 4.25 mm to less than or equal to 5.00 mm, from greater than or equal to 4.50 mm to less than or equal to 5.00 mm, or from greater than or equal to 4.75 mm to less than or equal to 5.00 mm. In embodiments, the thickness of the barrier layer is from greater than or equal to 1.00 mm to less than or equal to 4.75 mm, such as from greater than or equal to 1.00 mm to less than or equal to 4.50 mm, from greater than or equal to 1.00 mm to less than or equal to 4.25 mm, from greater than or equal to 1.00 mm to less than or equal to 4.00 mm, from greater than or equal to 1.00 mm to less than or equal to 3.75 mm, from greater than or equal to 1.00 mm to less than or equal to 3.50 mm, from greater than or equal to 1.00 mm to less than or equal to 3.25 mm, from greater than or equal to 1.00 mm to less than or equal to 3.00 mm, from greater than or equal to 1.00 mm to less than or equal to 2.75 mm, from greater than or equal to 1.00 mm to less than or equal to 2.50 mm, from greater than or equal to 1.00 mm to less than or equal to 2.25 mm, from greater than or equal to 1.00 mm to less than or equal to 2.00 mm, from greater than or equal to 1.00 mm to less than or equal to 1.75 mm, from greater than or equal to 1.00 mm to less than or equal to 1.50 mm, or from greater than or equal to 1.00 mm to less than or equal to 1.25 mm. In some embodiments, the thickness of the barrier layer 120 is from greater than or equal to 1.25 mm to less than or equal to 4.75 mm, such as from greater than or equal to 1.50 mm to less than or equal to 4.50 mm, from greater than or equal to 1.75 mm to less than or equal to 4.25 mm, from greater than or equal to 2.00 mm to less than or equal to 4.00 mm, from greater than or equal to 2.25 mm to less than or equal to 3.75 mm, from greater than or equal to 2.50 mm to less than or equal to 3.50 mm, or from greater than or equal to 2.75 mm to less than or equal to 3.25 mm.

The embodiments described herein will be further clarified by the following examples.

### EXAMPLES

Multilayer edible products according to embodiments disclosed and described herein were produced using the following ingredients for the center, the barrier layer, and the outer layer.

### Example 1

A nut-based center was formed by mixing the ingredients shown in Table 1 below until well mixed. Initially, the palm oil was melted down together with the sunflower oil (and other fat sources present) in a heated jacket with agitation to provide a consistent mixture. When the combined oil was completely fluid, the AlmondGOLD manufactured by Cache Creek Foods was added to the oils. After the AlmondGOLD was completely melted into the oils, the other ingredients and lecithin were added to the mixture.

TABLE 1

| Ingredient | Weight Percent |
|---|---|
| Pulverized Almonds | 77.56% |
| Low-melting temperature fat | 11.18% |
| High-melting temperature fat | 10.10% |
| Stabilizer | 0.54% |
| Flavoring | 0.60% |
| Sweetener | 0.02% |
| Total | 100 |

A barrier layer was formed by mixing the ingredients shown in Table 2 below until well mixed. All the dry ingredients (such as cake flour, inulin, and cinnamon) were mixed together in a Hobart mixer with a paddle attachment. Separately, the palm oil and other liquid oils (such as canola oil) were melted down into a liquid with agitation as needed. When the oil was completely liquid, water was added and the mixture was re-melted if the oil solidified upon addition of the water. The water and oil mixture was slowly drizzled into the dry ingredients while the dry ingredients were in the mixer while mixing. The glycerin was then slowly drizzled into the mixture of dry ingredients/water/oil in the mixer while mixing until it is completely combined and doughy. The dough was inspected to ensure there were no pellets of oil in the mixture.

TABLE 2

| Ingredient | Weight Percent |
|---|---|
| Hydrophilic powder | 52.04% |
| Flavoring | 0.75% |
| Low-melting temperature fat | 5.06% |
| High-melting temperature fat | 5.06% |
| Water | 4.00% |
| Glycerin | 28.09% |
| Fiber | 5.00% |
| Total | 100.0 |

Five outer layers were formed by mixing the ingredients shown in Tables 3-7 below until well mixed. All dry ingredients were mixed in a paddle mixer. Separately, the wet ingredients were combined and mixed. The wet ingredients were slowly poured into the dry ingredients while mixing. The combined wet and dry ingredients were mixed until they came together in a dough.

Four samples were prepared where the mixed center, barrier layer, and outer layer made as disclosed above were individually loaded into a triple extruder such as extruders from Aasted and Rheon, where the center composition (as shown in Table 1) is inserted into to the triple extruder so that it is extruded as a center portion of the extruded product, the barrier layer composition (as shown in Table 2) is inserted into the triple extruder so that it is extruded as an intermediate portion of the extruded product, and the outer layer compositions (as shown in Tables 3-6) is inserted into the triple extruder so that it is extruded as an outer portion of the extruded product.

TABLE 3

| INGREDIENT | WT % |
|---|---|
| OATS | 31.53% |
| FIBER | 32.85% |
| LOW-MELTING TEMPERATURE FAT | 10.49% |
| PROTEIN SOURCE | 17.64% |
| STARCH | 6.15% |
| STABILIZER | 0.44% |
| BAKING POWDER | 0.45% |
| FLAVORING | 0.45% |
| TOTAL | 100.00% |

The water activity of the center for this sample was 0.5321, and the water activity for the barrier layer of this sample was 0.5375, and the sample was successfully extruded as a three-layered product.

TABLE 4

| INGREDIENT | WT % |
|---|---|
| OATS | 31.04% |
| FIBER | 32.53% |
| LOW-MELTING TEMPERATURE FAT | 10.49% |
| PROTEIN | 14.82% |
| STARCH | 9.79% |
| STABILIZER | 0.44% |
| BAKING POWDER | 0.44% |
| FLAVORING | 0.45% |
| TOTAL | 100.00% |

The water activity of the center for this sample was 0.5649, and the water activity for the barrier layer of this sample was 0.5606, and the sample was successfully extruded, and the sample was successfully extruded as a three-layered product.

TABLE 5

| INGREDIENT | WT % |
|---|---|
| OATS | 31.04% |
| FIBER | 32.53% |
| LOW-MELTING TEMPERATURE FAT | 10.49% |
| PROTEIN | 14.82% |
| STARCH | 9.79% |
| STABLIZER | 0.44% |
| BAKING POWDER | 0.44% |
| FLAVORING | 0.45% |
| TOTAL | 100.00% |

The water activity of the center for this sample was 0.5610, and the water activity for the barrier layer of this sample was 0.5627, and the sample was successfully extruded as a three-layered product.

TABLE 6

| INGREDIENT | WT % |
|---|---|
| OATS | 31.04% |
| FIBER | 32.53% |
| LOW-MELTING TEMPERATURE FAT | 10.49% |
| PROTEIN | 14.82% |
| STARCH | 9.79% |
| STABILIZER | 0.44% |
| BAKING POWDER | 0.44% |
| FLAVORING | 0.45% |
| TOTAL | 100.00% |

The water activity of the center for this sample was 0.5268, and the water activity for the barrier layer of this sample was 0.5268, and the sample was successfully extruded as a three-layered product.

### Example 2

A nut-based center was formed by mixing the ingredients shown in Table 1 above until well mixed. Initially, the palm oil was melted down together with the sunflower oil (and other fat sources present) in a heated jacket with agitation to provide a consistent mixture. When the combined oil was completely fluid, the AlmondGOLD was added to the oils. After the AlmondGOLD was completely melted into the oils, the other ingredients and lecithin were added to the mixture.

A barrier layer was formed by mixing the ingredients shown in Table 7 below until well mixed. All the dry ingredients (such as cake flour, inulin, and cinnamon) were mixed together in a Hobart mixer with a paddle attachment. Separately, the palm oil and other liquid oils (such as canola oil) were melted down into a liquid with agitation as needed. When the oil was completely liquid, water was added and the mixture was re-melted if the oil solidified upon addition of the water. The water and oil mixture was slowly drizzled into the dry ingredients while the dry ingredients were in the mixer while mixing. The glycerin was then slowly drizzled into the mixture of dry ingredients/water/oil in the mixer while mixing until it is completely combined and doughy.

TABLE 7

| Ingredient | Weight Percent |
|---|---|
| Hydrophilic Powder | 52.04% |
| Flavoring | 0.75% |
| Low-melting temperature fat | 5.06% |
| High-melting temperature fat | 5.06% |
| Water | 4.00% |
| Glycerin | 28.09% |
| Fiber | 5.00% |
| Total | 100.0 |

Five outer layers were formed by mixing the ingredients shown in Tables 8-11 below until well mixed. All dry ingredients were mixed in a paddle mixer. Separately, the wet ingredients were combined and mixed. The wet ingredients were slowly poured into the dry ingredients while mixing. The combined wet and dry ingredients were mixed until they came together in a dough.

Four samples were prepared where the mixed center, barrier layer, and outer layer made as disclosed above were individually loaded into a triple extruder such as extruders from Aasted and Rheon, where the center composition (as shown in Table 1) is inserted into to the triple extruder so that it is extruded as a center portion of the extruded product, the barrier layer composition (as shown in Table 7) is inserted into the triple extruder so that it is extruded as an intermediate portion of the extruded product, and the outer layer compositions (as shown in Tables 8-11) is inserted into the triple extruder so that it is extruded as an outer portion of the extruded product.

TABLE 8

| Ingredient | WT % |
|---|---|
| OATS | 29.10% |
| PROTEIN | 17.75% |
| STARCH | 5.13% |
| BAKING POWDER | 0.43% |
| FIBER | 33.33% |
| HIGH-MELTING TEMPERATURE FAT | 3.30% |
| LOW-MELTING TEMPERATURE FAT | 10.08% |
| STABILIZER | 0.46% |
| FLAVORING | 0.42% |
| TOTAL | 100.00% |

This sample was successfully extruded as a three-layered product.

TABLE 9

| Ingredient | WT % |
|---|---|
| OATS | 29.10% |
| PROTEIN | 17.78% |
| STARCH | 5.13% |
| BAKING POWDER | 0.43% |
| FIBER | 33.33% |
| HIGH-MELTING TEMPERATURE FAT | 3.30% |
| LOW-MELTING TEMPERATURE FAT | 10.08% |
| STABILIZER | 0.43% |
| FLAVORING | 0.42% |
| TOTAL | 100.00% |

This sample was successfully extruded as a three-layered product.

TABLE 10

| INGREDIENT | WT % |
|---|---|
| OATS | 27.41% |
| PROTEIN | 18.00% |
| STARCH | 8.33% |
| BAKING POWDER | 0.42% |
| FIBER | 32.72% |
| LOW-MELTING TEMPERATURE FAT | 12.31% |
| STABILIZER | 0.42% |
| FLAVORING | 0.39% |
| TOTAL | 100.00% |

This sample was successfully extruded as a three-layered product.

TABLE 11

| INGREDIENT | WT % |
|---|---|
| OATS | 31.04% |
| PROTEIN | 14.83% |
| STARCH | 9.79% |
| BAKING POWDER | 0.44% |
| FIBER | 23.53% |
| SWEETENER | 9.00% |
| LOW-MELTING TEMPERATURE FAT | 10.49% |
| STABILIZER | 0.44% |
| FLAVORING | 0.44% |
| TOTAL | 100.00% |

This sample was successfully extruded as a three-layered product.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A multilayer edible product comprising:
a center;
a barrier layer directly encompassing at least a portion of the center, the barrier layer comprising:
a hydrophilic powder; and
a source of fat; and
an outer layer directly encompassing the barrier layer and indirectly encompassing the center,
wherein the center has at least one of:
a fat content that is either greater than or less than a fat content of the outer layer, or
a water activity that is either greater than or less than a water activity of the outer layer, and
wherein a composition of the barrier layer is different than a composition of the center and a composition of the outer layer, and
the multilayer edible product does not include any added sugar.

2. The multilayer edible product of claim 1, wherein the center has at least one of:
a fat content that is greater than the fat content of the outer layer, or
a water activity that is less than a water activity of the outer layer.

3. The multilayer edible product of claim 1, wherein the barrier layer has a thickness of less than or equal to 1.00 mm.

4. The multilayer edible product of claim 1, wherein the barrier layer has a thickness of less than or equal to 0.50 mm.

5. The multilayer edible product of claim 1, wherein the barrier layer has a thickness of greater than or equal to 1.00 mm.

6. The multilayer edible product of claim 1, wherein the barrier layer further comprises glycerin.

7. The multilayer edible product of claim 1, wherein the hydrophilic powder is selected from the group consisting of flour, fiber, artificial sweetener, and combinations thereof.

8. The multilayer edible product of claim 1, wherein the source of fat comprises a high-melting temperature fat.

9. The multilayer edible product of claim 8, wherein the high-melting temperature fat is selected from the group consisting of palm oil, coconut oil, and mixtures thereof.

10. The multilayer edible product of claim 1, wherein the barrier layer further comprises one or more additional components.

11. The multilayer edible product of claim 10, wherein the one or more additional components is selected from the group consisting of a natural or artificial flavor, colorant, and mixtures thereof.

12. The multilayer edible product of claim 1, wherein the barrier layer comprises:
greater than or equal to 35.0 wt % hydrophilic powder;
greater than or equal to 5.0 wt % of the fat source; and
greater than or equal to 10.0 wt % glycerin.

13. The multilayer edible product of claim 12, wherein the barrier layer comprises:
from greater than or equal to 35.0 wt % to less than or equal to 75.0 wt % hydrophilic powder;
from greater than or equal to 5.0 wt % to less than or equal to 35.0 wt % of the fat source; and
from greater than or equal to 10.0 wt % to less than or equal to 40.0 wt % glycerin.

14. The multilayer edible product of claim 1, wherein the barrier layer comprises:
greater than or equal to 50.0 wt % hydrophilic powder;
greater than or equal to 10.0 wt % of the fat source; and
greater than or equal to 25.0 wt % glycerin.

15. The multilayer edible product of claim 14, wherein
the hydrophilic powder is selected from the group consisting of flour, fiber, and mixtures thereof, and
the fat source comprises a high-melting temperature fat source selected from the group consisting of palm oil, coconut oil, and mixtures thereof.

16. The multilayer edible product of claim 1, wherein the barrier layer comprises:
from greater than or equal to 55.0 wt % to less than or equal to 70.0 wt % hydrophilic powder;
from greater than or equal to 5.0 wt % to less than or equal to 15.0 wt % of the fat source; and
from greater than or equal to 25.0 wt % to less than or equal to 40.0 wt % glycerin.

17. The multilayer edible product of claim 16, wherein
the hydrophilic powder is selected from the group consisting of flour, fiber, and mixtures thereof, and
the fat source comprises a high-melting temperature fat source selected from the group consisting of palm oil, coconut oil, and mixtures thereof.

18. The multilayer edible product of claim 1, wherein the center comprises:
greater than or equal to 60.0 wt % pulverized nuts;
greater than or equal to 5.0 wt % low-melting temperature fat; and
greater than or equal to 5.0 wt % high-melting temperature fat, wherein
the center has a viscosity less than or equal to 1000 Pa·s at temperatures less than or equal to 50° C.

19. The multilayer edible product of claim 18, wherein the pulverized nuts are selected from the group consisting of almonds, peanuts, cashews, chestnuts, hazelnuts, and mixtures thereof.

20. The multilayer edible product of claim 18, wherein the pulverized nuts are selected from almonds or peanuts.
